(19) United States
(12) Patent Application Publication
(10) Pub. No.: US 2025/0115687 A1
(43) Pub. Date: Apr. 10, 2025

(54) PRODUCTION METHOD FOR SOLID CATALYST COMPONENT FOR POLYMERIZING OLEFINS, AND CATALYST FOR POLYMERIZAING OLEFINS

(71) Applicant: Formosa Plastics Corporation, U.S.A., Livingston Township, NJ (US)

(72) Inventors: Guangxue Xu, Port Lavaca, TX (US); Demin Xu, Port Lavaca, TX (US); Cyrus C.J. Lee, Victoria, TX (US); Chih-Jian Chen, Port Lavaca, TX (US)

(21) Appl. No.: 18/482,696

(22) Filed: Oct. 6, 2023

(51) Int. Cl. C08F 4/76; C08F 110/06

(52) U.S. Cl. CPC C08F 4/76; C08F 110/06

(57) ABSTRACT

The present invention provides a process for producing a solid catalyst component without using internal electron donors, prepared by reacting an alkoxymagnesium compound with an acyl halide and/or sulfinyl halide and/or sulfonyl halide compound, and an alkanol and/or an alkanediol to form reaction product (A), optionally reacting the reaction product (A) with an organohalide and oranophosphorus compound to form reaction product (B), reacting the reaction product (B) with a halogen-containing titanium or vanadium compound to obtain the solid catalyst component (C). The solid catalyst component can be used in a olefin polymerization catalyst system to produce polypropylene polymers with high activity, high stereo-regularity, and good morphology.

### BACKGROUND

The present invention relates to a process for making Ziegler-Natta catalyst, and to polymerization processes to produce polyolefins. In particular, the inventive catalyst is suitable to produce polypropylene and copolymers with high activity, high stereo-regularity, and good morphology.

A solid catalyst that includes magnesium, titanium, an internal electron donor, a halogen atom, and an organoaluminum compound as essential compositions has been known as Ziegler-Natta type polyolefin catalysts. To obtain a higher isotacticity or crystallinity of the polymer, an external electron donor is needed in the process of olefin polymerization. A number of polyolefin catalysts have been proposed that include the solid catalyst component, an organoaluminum compound, and an external donor of organosilicon compound. The preferred classes of internal donors include phthalates that is an ester of phthalic acid, such as diisobutylphthalate, dibenzoic ester of 1,3-diol and polyol ester compounds, diethers, and succinates. These internal donors may be used in combination with alkylalkoxysilanes as an external donor, which are capable of giving good performances in terms of activity, and propylene polymer with high isotacticity and xylene or heptanes insolubility endowed with an intermediate molecular weight distribution.

It is known that highly stereospecific and highly active catalyst components with spherical shapes and uniform particles result in powdery polymers having a more satisfactory granular shape, a narrower particle size distribution, and higher bulk density, to thereby facilitate the fluidity of the produced powders, to increase productivity, to eliminate the fine powders of polymers, and to reduce the process clogging. U.S. Pat. No. 3,953,414 described the catalyst component applications to produce olefin polymers having spheroidal particles and controlled particle size distributions.

To prepare solid catalyst components with good morphology and bulk density, a number of methods or process for producing solid catalyst component have been proposed based on solid precursors/supports. The solid precursors/supports are commonly used, including magnesium halides, organic magnesium compounds, magnesium halide-silica-gel composites, magnesium halide-clay composites, polymer composites and magnesium halide adducts. The preferred precursors/supports are magnesium chloride, dialkoxy magnesium, chloroalkoxy magnesium and magnesium halide adducts. Examples of such precursors and their applications in catalyst component preparations are described in U.S. Pat. Nos. 3,901,863, 4,109,071, 4,220,554, 4,472,521, 4,547,476, 4,617,360, 4,816,433, 4,855,271, 5,075,270, 5,547,912, 5,849,655, 5,965,478, 7.329,626, 7,601,423, 7,879,751, 7,902,108, 7,989,382, 8,546,290, 9,206,273, 9,593,183, 9,815,918, 10,000,589, 10,113,014, and CN106674389, EP1273595, WO 2015/177733, and WO 2016/168108, each of which is incorporated by reference herein in its entirety.

U.S. Pat. Nos. 4,617,360 and 4,109,071 describe the catalyst components made from the precursors of combined compositions comprising halogen-and oxygen-containing magnesium compounds. Typical examples of these compositions are basic magnesium halides (preferably chlorides) and magnesium compounds containing both a magnesium/halogen bond and an organic radical, which is as defined above and is bonded to the magnesium via the oxygen, including chloroalkoxides and the chlorophenoxides such as Mg(OCH₃)Cl, Mg(OC₂H₅)Cl, and Mg(OC₆ H₅)Cl. U.S. Pat. No. 5,965,478 discloses the catalyst components prepared from the precursor diethoxymagnesium having good bulk density, spherical shapes, specific surface area and pore distributions, narrow particle size distributions, and less fine powders. The obtained polymers also have high bulk density, less fine powders, high activities, and high stereoregularity, especially for the production of copolymers and block copolymers.

U.S. Pat. No. 9,815,918 discloses magnesium complexes containing acid salts of group IB-VIIIB elements, which are prepared by co-crystallization or solidification from a solution containing both magnesium halide represented by formula MgXₙ(OR)₂₋ₙ and acid salts of group IB-VIIIB elements represented by formula MₘYₚ, and are further treated with internal electron donor and titanium compound to form the catalyst components. The modifications of catalyst supports or precursors can improve the catalyst performance in terms of activity and stereo-specificity

WO 2015/177733 discloses catalyst components prepared from magnesium powders by reacting with alcohol to form magnesium alkoxide, which is used as supports, further treated with internal donors and titanium compound to convert into the magnesium chloride catalyst components. After twice treatments with titanium compound, the solid components are further treated with titanium compound and benzoyl chloride to obtain a pro-catalyst. In this step, a second internal donor ethyl benzoate was formed in-situ. It is undetermined that second internal donor ethyl benzoate is formed due to the fact that two chlorination agents titanium compound and benzoyl chloride have different reactiveness and second internal donor ethyl benzoate has impact on the properties of catalysts and polypropylenes. This method shows the fines of catalyst components are high and the morphology control of catalyst components needs to be further improved.

U.S. Pat. No. 7,902,108 and EP1273595 disclose a process for making catalyst components by reacting a magnesium complex solution, prepared by adding a solution in toluene of BOMAG-A™ [Mg(Bu)_{1.5} (Oct)_{0.5}] into 2-ethylhexanol, phthaloyl chloride and chlorobutane, with a titanium compound to form an emulsion, and then an acrylic polymer is used to stabilize the emulsion and to solidify the particles forming the dispersed phase. The three-step process of catalyst preparation relates to making magnesium alkoxide solution, reacting with phthaloyl chloride to form the magnesium complex, and treating with titanium compound. To increase the magnesium alkoxide solubility and to form solution, the alcohols has long branch substitutes, which results in controlling the catalyst morphology such as particle sizes, distributions and shapes, and having limitations of internal donor in-situ formations. The catalytic activity and stereoregularity are still low, especially in propylene polymerizations.

U.S. Pat. No. 9,593,183 discloses a method by reacting anhydrous magnesium dichloride with 2,4-pentanediol and/or 3-ethyl-2.4-pentanediol to dissolve magnesium dichloride in decane and a benzoyl halide compound to prepare magnesium dichloride solution, which is further treated with titanium compound twice to prepare a solid components. Phthaloyl dichloride is used in comparative examples and catalysts show low activities and high xylene extractions. During the catalyst component preparations, the magnesium dichloride is dissolved to make solutions and then the catalyst components are participated from the solution. However, the catalyst preparations, related to the controls of catalyst formation such as particle sizes and distributions and shapes, still have limitations regarding of stirring speed control, temperature increase speed and chemical adding speed. The catalytic activity and stereoregularity still need to be further improved.

WO 2016/168108 discloses a process for preparing a solid catalyst component by dissolving the magnesium dichloride in toluene, epichlorohydrin and tributyl phosphate to make a solution, and further contacting with titanium compound, phthaloyl chloride as auxiliary donor and internal donors. The results demonstrate that the addition of the auxiliary donor to the support improves the magnesium dichloride surface by blocking atactic sites, but does not significantly affect the catalyst activity. The internal donor typically generates isotactic polymerization sites on the catalyst support providing the high catalytic activity for polymerization process. Atactic sites may be present in the catalyst resulting in undesirable polymer properties such as soluble atactic and low molecular weight polymer fractions. The combination of the auxiliary donor and the internal donor provides for a synergistic effect of the catalyst performance by blocking atactic sites and modifying the isotactic sites due to the competition between coordination on catalyst surface, and the ability to be removed by alkyl aluminum and external donors. The auxiliary donors are acyl halides and the internal electron donors are an ester, an ether, a ketone, or a combination of any two or more thereof. The xylene soluble contents still need to be improved, which indicates the isotacticity of polymers is not high enough for high flexible modulus applications.

Modifiers are commonly used to control catalyst formations and particle size and shapes, to improve catalyst and polymerization performance including the activity, stereoregularity, hydrogen response, molecular weight, and molecular weight distributions, and to finally involve in the final product physical properties. Acceptable modifiers, which are used in the solid Ziegler-Natta catalyst components during preparation of such catalysts, include organic compounds containing O, Si, N, S, and/or P, such as acyl chloride, esters, ethers, ketones, amines, alcohols, phenols, phosphorous compounds and silicon compounds.

From the prior art, it is understood that it is necessary to increase the amount of each internal electron donor compound in order to obtain a solid catalyst component having the desired internal electron donor compound content by simultaneously bringing two or more different internal donor compounds into contact with the other components to affect a reaction. In addition, the methods provided in the prior art were heterogeneous processes. As a result, an excess amount of complex formed between electron donor compound and the tetravalent titanium halide compound is easily produced, and the non-uniform distribution of stereoselective active species formed on the support particle is easily created. Therefore, the polymerization activity and the stereoregularity of the resulting polymer decreases when using the resulting solid catalyst component as a component of an olefin polymerization catalyst.

There is a continuing need for providing a method for producing a novel solid catalyst component having unique performance and uniform distribution of stereoselective active species formed on the support particle that achieves excellent olefin polymerization activity, and superior hydrogen response, higher stereoselectivity, and better operability during homopolymerization or copolymerization with other olefins, and can produce a polypropylene that exhibits a high MFR, high stereoregularity, and excellent rigidity.

### SUMMARY OF THE INVENTION

In accordance with the objectives of this invention, there is provided a Ziegler-Natta catalyst useful for the polymerization of olefins, having high activities, excellent stereoslectivity, and wide range of molecular weight control. The catalyst component for polymerization of olefins is capable of producing a polymer that has very low adherence ascribable to the stickiness of polymer particles, has excellent flowability, and also has a favorable particle size distribution and operability.

The present invention provides a process by selecting specific starting materials and employing specific manners for preparing a catalyst component comprising the magnesium-based support, internal donors formed in situ, and titanium compound.

The present invention also provides a method for preparing a catalyst by:
i) reacting a magnesium compound of the general formula R¹OMgOR² or R¹OMgX, in which R¹ and R² are same or different alkyl groups having from 1 to 20 carbon atoms, and X is halogen, with an acyl halide compound of the general formula RCOX in which R is a linear or branched C₁-C₂₀ alkyl or aromatic and X is independently halogen, and an alkanol of the general formula ROH in which R is a linear or branched C₁-C₂₀ alkyl or aromatic, and/or an alkanediol of the general formula Rₙ(OH)₂ in which n is 2 to 20, R(s) is/are a linear or branched C₁-C₂₀ alkyl or aromatic, to form reaction product (A);
ii) reacting the reaction product (A) with a organohalide compound and organophosphorus compounds obtained from RₙPOX₃₋ₙ in which n is from 0 to 3 and R(s) is/are a linear or branched C₁-C₂₀ alkyl or aromatic and X is independently halogen, to form reaction product (B);
iii) reacting the reaction product (B) with a titanium compound represented by the general formula TiXₙ(OR)₄₋ₙ in which R(s) is/are a linear or branched C₁-C₂₀ alkyl or aromatic, X(s) is/are independently halogen, and n is an integer of from 1 to 4, to obtain a solid product (C);
iv) treating the reaction product (C) with tetravalent titanium halide compound for 1-2 times at temperatures preferably 100 to 200° C.; and
v) mixing the solid product (C) with an external electron donor compound and an alkyl aluminum compound represented by the formula AlRₙX₃₋ₙ, wherein R(s) is/are a linear or branched C₁-C₁₀ alkyl or aromatic, X(s) is/are independently halogen, and n is a value meeting the condition of 1<n≤3.

The present invention also provides a method for preparing a catalyst by:
i) reacting a magnesium compound of the general formula R¹OMgOR² or R¹OMgX in which R¹ and R² are the same or different alkyl groups having from 1 to 20 carbon atoms and X is halogen, with a sulfinyl halide compound of the general formula R—S(═O)X or sulfonyl chloride of the general formula R—(O═)S(═O)X, in which R(s) is/are a linear or branched C₁-C₂₀ alkyl or aromatic and X is independently halogen, and an alkanol of the general formula ROH, in which R is a linear or branched C₁-C₂₀ alkyl or aromatic, and/or an alkanediol of the general formula Rₙ(OH)₂ in which n is 2 to 20, R(s) is/are a linear or branched C₁-C₂₀ alkyl or aromatic, to form reaction product (A);
ii) optionally reacting the reaction product (A) with a chlorinated epoxy compound and an organophosphorus compound obtained from RₙPOX₃₋ₙ in which n is from 0 to 3, R(s) is/are a linear or branched C₁-C₂₀ alkyl or aromatic, and X is independently halogen, to form reaction product (B);
iii) reacting the reaction product (B) with a titanium compound represented by the general formula TiXₙ(OR)₄₋ₙ in which R(s) is/are a linear or branched C₁-C₂₀ alkyl or aromatic, X(s) is/are independently halogen, and n is an integer of from 1 to 4, to obtain a solid product (C);
iv) treating the reaction product (C) with tetravalent titanium halide compound for 1-2 times at temperatures preferably 100 to 200° C.; and v) mixing the solid product (C) with an external electron donor compound and an alkyl aluminum compound represented by the formula AlRₙX₃₋ₙ, where R(s) is/are a linear or branched C₁-C₁₀ alkyl or aromatic, X(s) is/are independently halogen, and n is a value meeting the condition of 1<n≤3.

The present invention also provides a method for preparing a catalyst by:
i) reacting a magnesium compound of the general formula R¹OMgOR² or R¹OMgX in which R¹ and R² are same or different alkyl groups having from 1 to 20 carbon atoms and X is halogen, with an organohalogen compound of the general formula Rₙ(COX)₂ or Rₙ(SOX)₂ in which n is 2 to 10, R(s) is/are substituted or non-substituted linear or branched C₁-C₂₀ alkyl or aromatic and X is independently halogen, to form reaction product (A);
ii) optionally reacting the reaction product (A) with an organohalide and oranophosphorus compounds obtained from RₙPOX₃₋ₙ in which n is from 0 to 3 and R is hydrocarbyl or acromatic having 1 to 20 carbon atoms and X is independently halogen, to form reaction product (B),
iii) reacting the reaction product (B) with a titanium compound represented by the general formula TiXₙ(OR)₄₋ₙ in which R(s) is/are a linear or branched C₁-C₂₀ alkyl or aromatic, X(s) is/are independently halogen, and n is an integer of from 1 to 4, to obtain a solid product (C),
iv) treating the reaction product (C) with tetravalent titanium halide compound for 1-2 times at temperatures preferably 100 to 200° C.,
v) mixing the solid product (C) with an alkyl aluminum compound represented by the formula AlRₙX₃₋ₙ, wherein R(s) is/are a linear or branched C₁-C₁₀ alkyl or aromatic, X(s) is/are independently halogen, and n is a value meeting the condition of 1<n≤3, and an external electron donor compound.

The present invention offers a wide range of catalyst component preparations to enhance and improve the catalyst performance regarding activity, stereo-specificity, hydrogen response, molecular weight and molecular weight distributions, physical property of final polyolefin products, particularly polypropylene and its copolymers.

### DETAILED DESCRIPTION

The present invention relates to methods of making polymerization catalyst component comprising a magnesium-based support, internal donors formed in situ, and titanium compound, to polymerization of olefins CH₂═CHR in which R is hydrogen or C₁-₁₂ hydrocarbyl to produce polyolefins. In particular, the catalyst can be suitable to produce polypropylene polymers and copolymer with high activity, high stereo-regularity, and good morphology.

The present invention provides a process for producing an olefin polymerization catalyst system, prepared by reacting an alkoxymagnesium compound with an acyl halide or sulfinyl halide or sulfonyl halides compound and an alkanol or an alkanediol to form reaction product (A), reacting the reaction product (A) with an organohalide and oranophosphorus compound to form reaction product (B), reacting the reaction product (B) with a halogen-containing titanium or vanadium compound to obtain a solid product (C) of magnesium composite support, internal donors formed in situ, and titanium compound, and then mixing the solid product (C) with an alkyl aluminum compound to form the catalyst system.

The method for producing a solid catalyst component and catalyst system for polymerization of olefins according to the present invention will be described.

In the method for producing a solid catalyst component for polymerization of olefins, a magnesium compound having an alkoxy group is used and has the general formula R¹OMgOR² or R¹OMgX, wherein R¹ and R² are the same or different alkyl groups having from 1 to 20 carbon atoms and X is halogen.

In preferred embodiments of the present invention, the magnesium compound having an alkoxy group is preferably dialkoxy magnesium. Examples of the dialkoxy magnesium can include one or more compounds selected from, but not limited to: dibutoxy magnesium, diethoxy magnesium, dipropoxy magnesium, dimethoxy magnesium, dipentoxy magnesium, diisooctoxy magnesium, ethoxymethoxy magnesium, ethoxybutoxy magnesium, ethoxypropoxy magnesium, and ethoxyisooctoxy magnesium. The dialkoxy magnesium may be used alone or in combination of two or more thereof. Diethoxy magnesium is the most preferred magnesium compound.

The dialkoxy magnesium may be dialkoxy magnesium obtained by reacting magnesium metal with an alcohol in the presence of a halogen, a halogen-containing metal compound, or the like.

The particles of the magnesium compound having an alkoxy group are in a granular or powdery form in a dry state when implementing the method for producing a solid catalyst component for olefin polymerization according to one embodiment of the invention. The dialkoxy magnesium may have an indefinite shape or a spherical shape. When the spherical dialkoxy magnesium is used, the resulting polymer powder has a better (more spherical) particle shape and a narrower particle size distribution. This makes it possible to improve the handling capability of the polymer powder produced during polymerization, and eliminate occurrence of a problem (e.g., clogging) due to a fine powder included in the polymer powder.

The particles of the magnesium compound having an alkoxy group are in a granular or powdery form in a dry state. The shape thereof is usually a spherical shape, but is not necessarily required to be a true spherical shape and may be an ellipsoidal shape. The bulk specific gravity of the magnesium compound having an alkoxy group is preferably about 0.1 to about 0.6 g/ml, more preferably about 0.2 to about 0.5 g/ml, and most preferably about 0.25 to about 0.40 g/ml. The average particle size D50 (i.e., the particle size at 50% in the cumulative volume particle size distribution) of the dialkoxy magnesium, measured using a laser diffraction/scattering particle size distribution analyzer, is preferably about 1 to about 200 μm, and more preferably about 5 to about 150 μm. For the spherical dialkoxy magnesium, the average particle size is preferably about 1 to about 100 μm, more preferably about 5 to about 60 μm, and most preferably about 10 to about 50 μm.

It is preferred that the dialkoxy magnesium particles have a narrow particle size distribution and have low fine particle content and low coarse particle content, as measured by a laser diffraction/scattering particle size distribution analyzer. More specifically, it is preferable that the content of fine dialkoxy magnesium particles equal to or smaller than 5 μm is about 20% or less, and more preferably about 10% or less. The content of coarse particles equal to or larger than 100 μm is preferably about 10% or less, and more preferably about 5% or less. The particle size distribution with the ratio of D90/D10 of the spherical dialkoxy magnesium is preferably about 3 or less, and more preferably about 2 or less, wherein D90 is the particle size at 90% in the cumulative volume particle size distribution, and D10 is the particle size at 10% in the cumulative volume particle size distribution.

In the method for producing a solid catalyst component for polymerization of olefins in present invention, it is preferred that the magnesium compound be used in the form of a solution or a suspension when subjected to the reaction. When the magnesium compound is used in the form of a solution or a suspension, the reaction proceeds advantageously. When the magnesium compound is solid, the magnesium compound may be dissolved in a solvent that can dissolve the magnesium compound to prepare a magnesium compound solution, or may be suspended in a solvent to form a magnesium compound suspension. The saturated hydrocarbon solvent and the unsaturated hydrocarbon solvent used in the present invention include linear or branched aliphatic hydrocarbon compounds having a boiling point of 50° C. to 200° C., such as hexane, heptane, decane, and methylheptane; alicyclic hydrocarbon compounds having a boiling point of 50° C. to 200° C., such as cyclohexane, ethylcyclohexane, and decahydronaphthalene; and aromatic hydrocarbon compounds having a boiling point of 50° C. to 200° C., such as toluene, xylene, and ethylbenzene. Among these, linear aliphatic hydrocarbon compounds having a boiling point of 50° C. to 200° C., such as hexane, heptane, and aromatic hydrocarbon compounds having a boiling point of 50° C. to 200° C., such as toluene, and xylene are preferred.

In the method for producing a solid catalyst component for polymerization of olefins, an acyl halide is used comprising an organic compound with the functional group —C(═O)X and having the general formula RCOX in which R is a linear or branched C₁-C₂₀ alkyl or aromatic having 1 to 20 carbon atoms, and X is a halogen, preferably chlorine.

In a preferred embodiment of the present invention, the acyl halide with the functional group —C(═O)X is preferably an acyl chloride with the functional group —C(═O)Cl. Examples of the acyl chloride can include one or more compounds selected from, but not limited to: acyl chloride, acetyl chloride, acryloyl chloride, adipoyl chloride, anisoyl chloride, azelaoyl chloride, benzoyl chloride, bromodifluoroacetyl chloride, butyryl chloride, 2-methylbutanoyl chloride, chloroacetyl chloride, dichloroacetyl chloride, diethymalony dichloride, dimethymalony chloride, dimethylcarbamoyl chloride, 3,5-dinitrobenzoyl chloride, fluoroacetyl chloride, 2-furoyl chloride, glutaryl chloride, heptanoyl chloride, hexanoyl chloride, isobutyryl chloride, lauroyl chloride, malonyl chloride, methacryloyl chloride, octanoyl chloride, oxalyl chloride, pentanoyl chloride, phosgene, pimeloyl chloride, pivaloyl chloride, propionyl chloride, sebacoyl chloride, suberoyl chloride, succinyl chloride, terephthaloyl chloride, thioacyl chloride, trichloroacetyl chloride, 2,4,6-trichlorobenzoyl chloride, trifluoroacetyl chloride, trimellitic anhydride chloride, and 2,4,6-trichlorobenzoyl chloride.

In the method for producing a solid catalyst component for polymerization of olefins, an organohalide compound having the general formula RX may be used, wherein R is a linear or branched C₁-C₂₀ alkyl or aromatic having 1 to 20 carbon atoms, and X is halogen, preferably chlorine. Typical an organohalide compound can include one or more compounds selected from, but not limited to: epichlorohydrin, alkyl chloride such as butyl chloride, and aryl chloride such as benzyl chloride.

In the method for producing a solid catalyst component for polymerization of olefins, sulfinyl halide and/or sulfonyl halides used in present invention are organic compounds with the functional groups —S(═O)—X having the general formula R—S(═O)X, or the functional group —(O═)S(═O)—X having the general formula R—(O═)S(═O)X, respectively, wherein R is a linear or branched C₁-C₂₀ alkyl or aromatic having 1 to 20 carbon atoms, and X is halogen.

In preferred embodiments of the present invention, the sulfinyl halide is preferably sulfinyl chloride having the formula R—S(═O)Cl, and the sulfonyl halide is preferably sulfonyl chloride with the general formula R—(O═)S(═O)Cl, in which the R is a linear or branched C₁-C₂₀ alkyl or aromatic having 1 to 20 carbon atoms.

Examples of the sulfinyl chloride and sulfonyl chloride include one or more compounds selected from, but not limited to: sulfuryl chloride, sulfonyl halide, thionyl chloride, chlorosulfate, chlorosulfate, 1,2-benzenedisulfonyl chloride, 1,3-benzenedisulfonyl chloride, 1,3-benzodioxole-5-sulfonyl chloride, 1,4-benzodioxane-6-sulfonyl chloride, 1-(4-trifluoromethyl-2-pyrimidinyl)-1H-pyrazole-4-sulfonyl chloride, 1-(5-trifluoromethyl-2-pyridyl)-1H-pyrazole-4-sulfonyl chloride, 1-acetylindoline-5-sulfonyl chloride, 1-butanesulfonyl chloride, 1-decanesulfonyl chloride, 1-dodecanesulfonyl chloride, 1-hexadecanesulfonyl chloride, 1-methyl-1H-pyrazole-4-sulfonyl chloride, 1-octadecanesulfonyl chloride, 1-octanesulfonyl chloride, 1-propanesulfonyl chloride, (1R)-(−)-camphor-10-sulfonyl chloride, (1S)-(+)-camphor-10-sulfonyl chloride, 2,1,3-benzothiadiazole-4-sulfonyl chloride, 2,2-difluoro-2-(fluorosulfonyl)acetic acid, 2,3,4,5,6-pentafluorobenzenesulfonyl chloride, 2,3,4-trichlorobenzenesulfonyl chloride, 2,3,4-trifluorobenzenesulfonyl chloride, 2,3,5,6-tetramethylbenzenesulfonyl chloride, 2,3,5-trifluorobenzenesulfonyl chloride, 2,3,6-trifluorobenzenesulfonyl chloride, 2,3-dichlorobenzenesulfonyl chloride, 2,3-dihydrobenzo[b]furan-5-sulfonyl chloride, 2,4,5-trichlorobenzenesulfonyl chloride, 2,4,5-trifluorobenzenesulfonyl chloride, 2,4,6-trichlorobenzenesulfonyl chloride, 2,4,6-trifluorobenzenesulfonyl chloride, 2,4,6-triisopropylbenzenesulfonyl chloride, 2,4-dibromobenzenesulfonyl chloride, 2,4-dichloro-5-methylbenzenesulfonyl chloride, 2,4-dichlorobenzenesulfonyl chloride, 2,4-difluorobenzenesulfonyl chloride, 2,4-dimethylbenzenesulfonyl chloride, 2,4-dimethylthiazole-5-sulfonyl chloride, 2,4-dinitrobenzenesulfonyl chloride, 2,4-dioxo-1,2,3,4-tetrahydropyrimidine-5-sulfonyl chloride, 2,4-dioxo-1,2,3,4-tetrahydroquinazoline-6-sulfonyl chloride, 2,5-bis(trifluoromethyl)benzenesulfonyl chloride, 2,5-dibromobenzenesulfonyl chloride, 2,5-dichlorobenzenesulfonyl chloride, 2,5-dichlorothiophene-3-sulfonyl chloride, 2,5-difluorobenzenesulfonyl chloride, 2,5-dimethoxybenzenesulfonyl chloride, 2,5-dimethylbenzenesulfonyl chloride, and 2,6-dichlorobenzenesulfonyl chloride.

In the method for producing a solid catalyst component for the polymerization of olefins in the present invention, the organophosphorus compound is preferably phosphoryl chloride (commonly called phosphorus oxychloride) and the reaction product derived therefrom is phosphoryl chloride (POCl₃).

In preferred embodiments of the present invention, the organophosphorus compound includes one or more compounds selected from, but not limited to: phosphoryl chloride (POCl₃), diphenylphosphinic chloride, methylphosphonic dichloride, methylenebis(phosphonic dichloride), methylphosphonyl dichloride, methylphosphonyl dichloride, phenylphosphonic dichloride, phenylphosphonic dichloride, diphenylphosphinic chloride, phenylphosphonic dichloride, phosphonic acid, (chlorophenylmethyl)-dimethyl ester, (2-chloroethyl)phosphonoyl dichloride, methylphosphonyl dichloride, methylenebis(phosphonic dichloride), chloromethylphosphonic dichloride, (2-chloroethyl)phosphonic dichloride, phosphinic acid chloride, phosphonic dichloride, chloridophosphate, chlorothiophosphate, diethyl phosphorochloridate, and tributyl phosphate.

According to a preferred embodiment of the present invention, alcohols can also be used to make the catalyst component either as a single compound or as combination with two or three compounds including, but not limited to: mono alcohol, diol, polyols, and the like. It is believed that alcohols can make the reaction more homogenous and produce more uniform distribution of the active site species on the magnesium composite support.

In the method for producing a solid catalyst component for the polymerization of olefins, an alkanol having the general formula ROH is used in present invention, wherein he R is a linear or branched C₁-C₂₀ alkyl or aromatic. Typical monohydric alcohols include, but are not limited to: methanol, n-propanol, iso-propanol, n-butanol, iso-butanol, sec-butanol, tert-butanol, n-amyl alcohol, iso-amyl alcohol, sec-amyl alcohol, tert-amyl alcohol, diethyl carbinol, sec-isoamyl alcohol, tert-butyl carbinol, hexanol, 2-ethyl-1-butanol, 4-methyl-2-pentanol, 1-heptanol, 2-heptanol, 4-heptanol, 2,4-dimethyl-3-pentanol, 1-octanol, 2-octanol, 2-ethyl-1-hexanol, 1-nonanol, 5-nonanol, diisobutylcarbinol, 1-decanol, 2,7-dimethyl-2-octanol, n-1-undecanol, n-1-dodecanol, n-1-heptadecanol, and n-1-octadecanol.

The alkanol having the general formula ROH may also be an alcohol comprising in addition to the hydroxyl moiety at least one further oxygen bearing group being different to a hydroxyl moiety. Typically, such further oxygen bearing group is an ether moiety. This kind of alcohol may be aliphatic or aromatic, although aliphatic compounds are preferred. The aliphatic compounds may be linear, branched, cyclic, or any combination thereof. Preferred alkanols are those comprising one ether moiety, examples including, but not limited to: ethylene glycol butyl ether, ethylene glycol hexyl ether, ethylene glycol 2-ethylhexyl ether, 1,3-propylene glycol n-butyl ether, propylene glycol methyl ether, 1,3-propylene glycol ethyl ether, propylene glycol n-hexyl ether, and propylene glycol 2-ethylhexyl ether.

In the method for producing a solid catalyst component for polymerization of olefins, an alkanediol having the general formula Rₙ(OH)₂ is used in present invention, wherein n is 2 to 20, and the R(s) is/are linear or branched C₁-C₂₀ alkyl or aromatic groups. In general, the alkanediol is a diol or glycol, which a chemical compound containing two hydroxyl groups (—OH groups) such as geminal diols, vicinal diols, 1,3-diols, 1,4-diols, 1,5-diols, and longer diols. Vicinal diols have hydroxyl groups attached to adjacent atoms. Examples of preferred vicinal diol compounds are ethylene glycol and propylene glycol. Geminal diols have hydroxyl groups bonded to the same atom. For example, carbonic acid ((HO)₂C═O) is a geminal diol that is unstable and has a tendency to convert to carbon dioxide (CO₂) and water (H₂O).

In preferred embodiments of the present invention, the alkanediols or diols includes one or more compounds selected from, but not limited to: 1,2-ethanediol, 1,2-cyclohexanediol, 5-tert-butyl-3-methylbenzene-1,2-diol, 2-methyl-2-propyl-1,3-propanediol and neopentyl glycol (2,2-dimethylpropane-1,3-diol), 4-methyl-1-phenylpentane-1,3-diol, 4-methylcyclopentane-1,3-diol, 2,2-Dimethoxypropane-1,3-diol, 1,3-butylene glycol or butane-1,3-diol, 1,3-propanediol, 2,2,4-trimethylpentane-1,3-diol, 1,3-cyclohexanediol, 2-Ethylhexane-1,3-diol, 2,4-pentanediol, 1,4-pentanediol, 1,4-butanediol, 1,5-pentanediol, 1,6-hexanediol, and 1,10-decanediol.

In the method for producing a solid catalyst component for the polymerization of olefins according to the present invention, a titanium compound represented by the general formula TiXₙ(OR)₄₋ₙ is employed, wherein the R(s) is/are linear or branched alkyl group having from 1 to 20 carbon atoms, X(s) is/are halogen, and n is an integer of from 1 to 4.

In the titanium compound represented by the general formula TiXₙ(OR)₄₋ₙ. preferred examples of the halogen atom X include a fluorine atom, a chlorine atom, a bromine atom, and an iodine atom. R is a linear or branched alkyl group having 1 to 20 carbon atoms, preferably an alkyl group having 1 to 7 carbon atoms, more preferably an alkyl group having 1 to 4 carbon atoms. Specific examples of R include a methyl group, an ethyl group, a propyl group, an isopropyl group, a n-butyl group, an isobutyl group, a tert-butyl group, a n-pentyl group, an isopentyl group, a neopentyl group, a hexyl group, and an isohexyl group.

Examples of the titanium compound represented by the general formula TiXₙ(OR)₄₋ₙ n specifically include titanium tetra-halides such as titanium tetrachloride, titanium tetrabromide and titanium tetraiodide; and alkoxy titanium halides such as methoxy titanium trichloride, ethoxy titanium trichloride, propoxy titanium trichloride, butoxy titanium trichloride, dimethoxy titanium dichloride, diethoxy titanium dichloride, dipropoxy titanium dichloride, dibutoxy titanium dichloride, trimethoxy titanium chloride, ethoxy titanium trichloride, tripropoxy titanium chloride, tributoxy titanium chloride, tetraalkoxytitaniums such as Ti(OCH₃)₄, Ti(OC₂H₅)₄, Ti(O-n-C₄H₉)₄. Ti(O-iso-C₄H₉)₄, and Ti(O-2-ethylhexyl) 4; and other compounds such as Ti[O—C(CH₃)CH—CO—CH]₂Cl₂. Ti[N(C₂H₅)₂]Cl₃, Ti[N(C₆H₅)₂]Cl₃, Ti(C₆H₅COO)Cl₃, [N(C₄H₉)₄]₂TiCl₆, [N(CH₃)₄]Ti₂Cl₉, TiBr₄, TiCl₃OSO₂C₆H₅, and LiTi(OC₃H₇)₂Cl₃.

The titanium compound represented by the general formula TiXₙ(OR)₄₋ₙ is preferably titanium tetrahalide, more preferably titanium tetrachloride.

The titanium compound represented by the general formula TiXₙ(OR)₄₋ₙ may be used alone or in combination of two or more thereof, and diluted with a hydrocarbon compound or a halogenated hydrocarbon compound.

The method for producing a solid catalyst component for polymerization of olefins according to the present invention comprises the step of bringing the magnesium compound having an alkoxy group, and the acyl halide or the acyl halide/alkanol mixture or the acyl halide/alkanediol mixture or the combination of acyl halide/alkanol/alkanediol into contact with each other to form reaction product (A), wherein for the contact between the magnesium compound having an alkoxy group and the acyl halide or the acyl halide/alkanol mixture or the acyl halide/alkanediol mixture or the combination of acyl halide/alkanol/alkanediol, the magnesium compound having an alkoxy group is slowly added to the acyl halide or the acyl halide/alkanol mixture or the acyl halide/alkanediol mixture or the combination of acyl halide/alkanol/alkanediol at a temperature from about 20° C. to about 120° C., preferably from about 40° C. to about 80° C., or alternatively the acyl halide or the acyl halide/alkanol mixture or the acyl halide/alkanediol mixture or the combination of acyl halide/alkanol/alkanediol is slowly added to the magnesium compound having an alkoxy group continuously or intermittently over 1 hour or longer. The reaction mixture is continuously stirred at a temperature from 40° C. to 120° C., preferably from 60° C. to 80° C., for over 3 hours or longer until the peak of acyl halide has disappeared as monitored with GC-MS.

The method for producing a solid catalyst component for polymerization of olefins according to the present invention also comprises the step of bringing the magnesium compound having an alkoxy group, the sulfinyl halide or the sulfinyl halide/alkanol mixture or the sulfinyl halide/alkanediol mixture or the combination of sulfinyl halide/alkanol/alkanediol into contact with each other to form reaction product (A), wherein for the contact between the magnesium compound having an alkoxy group and the sulfinyl halide or the sulfinyl halide/alkanol mixture or the sulfinyl halide/alkanediol mixture or the combination of sulfinyl halide/alkanol/alkanediol, the magnesium compound having an alkoxy group is slowly added to the sulfinyl halide or the sulfinyl halide/alkanol mixture or the sulfinyl halide/alkanediol mixture or the combination of sulfinyl halide/alkanol/alkanediol at a temperature from about 20° C. to about 120° C., preferably from about 40° C. to about 80° C., or alternatively the sulfinyl halide or the sulfinyl halide/alkanol mixture or the sulfinyl halide/alkanediol mixture or the combination of sulfinyl halide/alkanol/alkanediol is slowly added to the magnesium compound having an alkoxy group continuously or intermittently over 1 hours or longer. The reaction mixture is continuously stirred at a temperature from about 40° C. to about 120° C., preferably from about 60° C. to about 80° C., for over 3 hours or longer until the peak of sulfinyl halide has disappeared as monitored with GC-MS.

The method for producing a solid catalyst component for polymerization of olefins according to the present invention also comprises the step of bringing the magnesium compound having an alkoxy group, the sulfonyl halide or the sulfonyl halide/alkanol mixture or the sulfonyl halide/alkanediol mixture or the combination of sulfonyl halide/alkanol/alkanediol into contact with each other to form reaction product (A), wherein for the contact between the magnesium compound having an alkoxy group and the sulfonyl halide or the sulfonyl halide/alkanol mixture or the sulfonyl halide/alkanediol mixture or the combination of sulfonyl halide/alkanol/alkanediol, the magnesium compound having an alkoxy group is slowly added to the sulfonyl halide or the sulfonyl halide/alkanol mixture or the sulfonyl halide/alkanediol mixture or the combination of sulfonyl halide/alkanol/alkanediol at a temperature from about 20° C. to about 120° C., preferably from about 40° C. to about 80° C., or alternatively the sulfonyl halide or the sulfonyl halide/alkanol mixture or the sulfonyl halide/alkanediol mixture or the combination of sulfonyl halide/alkanol/alkanediol is slowly added to the magnesium compound having an alkoxy group continuously or intermittently over 1 hour or longer. The reaction mixture was continuously stirred at a temperature from about 40° C. to about 120° C., preferably from about 60° C. to about 80° C., for over 3 hours or longer until the peak of sulfonyl halide disappeared as monitored with GC-MS.

The method for producing a solid catalyst component for polymerization of olefins according to the present invention further comprises the step of bringing the reaction product (A), and an organochlorine compound such as epichlorohydrin and an organophosphorus compound such as tributylphosphate into contact with each other to form reaction product (B), wherein the reaction product (A) is slowly added to the organochlorine compound and the organophosphorus compound at a temperature from about 20° C. to about 100° C., preferably from about 40° C. to about 60° C., or alternatively the organochlorine compound and the organophosphorus compound is slowly added to the reaction product (A) continuously or intermittently over 1 hour or longer. The reaction mixture is continuously stirred at a temperature from about 20° C. to about 100° C., preferably from about 40° C. to about 60° C., for over 1.5 hours or longer.

The method for producing a solid catalyst component for polymerization of olefins according to the present invention further comprises the step of bringing the reaction product (A) or the reaction product (B), and the tetravalent titanium halide compound into contact with each other at low temperature in the presence of the inert organic solvent. The tetravalent titanium halide compound is slowly added to the reaction product (A) or the reaction product (B) at a temperature lower than the reaction temperature. This low-temperature aging treatment brings the components including reaction product (A) or reaction product (B) and tetravalent titanium halide compound into contact each other at a temperature lower than the reaction temperature. The cooling temperature of components contact each other is preferably from about −40 to about 20° C., more preferably from about −30 to about 10° C., and most preferably from about −20 to about 0° C. The low-temperature aging time is preferably from about 10 minutes to about 2 hours, more preferably from about 30 minutes to about 1 hour.

To produce solid catalyst component or reaction product (C), the reaction temperature between reaction product (A) or reaction product (B) and tetravalent titanium halide compound is preferably about 0 to about 130° C., more preferably about 40 to about 130° C., and most preferably about 50 to about 120° C., and yet more preferably 100 to 120° C. The reaction time is preferably about 1 minute or more, more preferably about 30 minutes or more, and most preferably about 1 hour to about 6 hours, still most preferably about 2 hours to about 4 hours.

After completion of the reaction, it is preferable to wash the reaction product after allowing the reaction mixture to stand, appropriately removing the supernatant liquid to achieve a wet state (slurry state). The slurry reaction product is washed using the inert organic solvent (washing agent). The washing agent is preferably one or more compounds selected from linear aliphatic hydrocarbon compounds (i.e., hexane, heptane and decanc), alicyclic hydrocarbon compounds (i.e., methylcyclohexane and ethylcyclohexane), and aromatic hydrocarbon compounds (i.e., toluene, xylene, ethylbenzene, and o-dichlorobenzene). The reaction product is preferably washed at about 0 to about 120° C., more preferably about 30 to about 110° C., still more preferably about 80 to about 110° C., and most preferably about 100 to about 110° C.

When implementing the method for producing a solid catalyst component (C) for olefin polymerization according to one embodiment of the invention, it is preferable to wash the reaction product by adding the desired amount of washing agent to the reaction product, stirring the mixture, and removing the liquid phase using a filtration method or a decantation method. Through washing process, it is highly possible to remove unreacted raw material components, reaction by-products (e.g., alkoxytitanium halide and titanium tetrachloride-carboxylic acid complex, if any), and impurities. The reaction product is preferably washed 1 to 15 times, more preferably 2 to 10 times, and still more preferably 2 to 5 times.

In the method for producing a solid catalyst component for polymerization of olefins according to one embodiment of the invention, a post-treatment may be performed by a tetravalent titanium halide compound after washing the reaction product (C) or solid catalyst component (C). More specifically, a tetravalent titanium halide compound may be brought into contact with the reaction product obtained by the reaction, or the reaction product that has been washed, or the reaction product that has been washed after bringing a tetravalent titanium halide compound into contact with the reaction product (C). Post-treatment reaction temperature between reaction product (C) and tetravalent titanium halide compound is preferably about 0 to about 130° C., more preferably about 40 to about 130° C., still more preferably about 50 to about 120° C., and most preferably about 100 to about 120° C. The post-treatment reaction time is preferably about 1 minute or more, more preferably about 30 minutes or more, still more preferably about 1 hour to about 6 hours, and most preferably about 2 hours to about 4 hours. The reaction product may be washed after or during the post-treatment in the same manner as described above.

When implementing the method for producing a solid catalyst component for olefin polymerization according to the invention, the reaction product (C) subjected to the post-treatment may be subjected to the second post-treatment reaction. The second post-treatment reaction between the reaction product & solid catalyst component (C) with tetravalent titanium halide compound is conducted in the same manner as discussed for the first post-treatment step. The final reaction product or solid catalyst component (C) may be washed after or during the second post treatment in the same manner as described for the first post treatment.

The present invention is unique and different from the methods described in the prior art. In the prior art, to prepare catalyst components for olefin polymerization, especially for propylene polymerization, internal electron donor compounds must be directly added during the preparation of the catalyst component to improve catalyst performance such as catalyst activity, stereo-selectivity, molecular weight and molecular weight distribution, commoner incorporation, and short/long chain branching distribution. In general, prior art processes bring the magnesium compound, the tetravalent titanium halide compound, and internal electron donor compound into contact with each other to form the solid catalyst component. A second step may then be used to finalize the catalyst component, the second step contacting the tetravalent titanium halide compound and one or more second internal electron donor compounds with the product obtained by the first step to finalize a reaction, followed by washing. A third step may also be applied to treat the product of the second step by adding the tetravalent titanium halide compound and one or more second internal electron donors. Examples of internal electron donor compounds used in the prior art, including phthalates, polycarboxylic acid ester, carboxylic acid ester, diol esters, diethers, and succinates, are described in U.S. Pat. Nos. 4,107,414, 4,186,107, 4,226,963, 4,347,160, 4,382,019, 4,435,550, 4,465,782, 4,530,912, 4,532,313, 4,560,671, 4,657,882, 5,106,807, 5,208,302, 5,723,400, 5,902,765, 5,948,872, 6,121,483, 6,436,864, 6,605,562, 6,770,586, 6,683,017, 6,818,583, 6,822,109, 6,825,309, 7,022,640, 7,049,377, 7,202,314, 7,208,435, 7,223,712, 7,324,431, 7,351,778, 7,371,802, 7,388,061, 7,420,021, 7,491,781, 7,544,748, 7,674,741, 7,674,943, 7,888,437, 7,888,438, 7,964,678, 8,003,558, 8,003,559, 8,088,872, 8,211,819, 8,222,357, 8,227,370, 8,236,908, 8,247,341, 8,263,520, 8,263,692, 8,288,304, 8,288,585, 8,318,626, 8,383,540, 8,470,941, 8,536,290, 8,569,195, 8,575,283, 8,604,146, 8,633,126, 8,692,927, 8,664,142, 8,680,222, 8,716,417, 8,716,514, 8,740,947, 9,156,927, 9,790,291, 9,815,918, 9,815,920, and US2018/0051105A1, each of which is incorporated by reference herein in its entirety.

In the method for producing a solid catalyst component of the present invention, internal electron donors are not directly used. In the present invention, it is believed that internal electron donors or internal electron donor intermediates are formed in-situ, creating strong synergies having superior catalytic performance much higher than reported in the prior art, as demonstrated in Examples hereinbelow. In addition, the methods of the present invention provide a novel solid catalyst component having unique performance and uniform distribution of stereoselective active species formed on support particles that achieves excellent olefin polymerization activity and higher hydrogen response during homopolymerization or copolymerization with other olefins, and can produce a polypropylene that exhibits a high MFR, high stereoregularity, and excellent rigidity.

The olefin polymerization catalyst (D) according to the present invention is produced by bringing the solid catalyst component (C), an organoaluminum compound represented by the general formula AlRₙX₃₋ₙ, wherein the R(s) is/are a linear or branched C₁-C₁₀ alkyl or aromatic, the X(s) is/are independently halogen, and n is a value meeting the condition of 1<n≤3, and an external electron donor compound into contact with each other.

Specific examples of the organoaluminum compound represented by the general formula AlRₙX₃₋ₙ, include triethylaluminum, diethylaluminum chloride, triisobutylaluminum, diethylaluminum bromide, trioctylaluminum, and diethylaluminum hydride. Among these, tricthylaluminum and triisobutylaluminum are preferred. The organoaluminium compound is used in a molar ratio of from about 1 to about 1000 per atom of titanium in the catalyst component.

Examples of the external electron compound used to produce the olefin polymerization catalyst according to one embodiment of the invention may include organic compounds that contain an oxygen atom or a nitrogen atom, such as alcohols, phenols, ethers, esters, ketones, acid halides, aldehydes, amines, amides, nitriles, isocyanates, organosilicon compounds that contain a Si—O—C linkage, and aminosilane compounds that contain a Si—N—C linkage. Among these, esters such as ethyl benzoate, ethyl p-methoxybenzoate, ethyl p-ethoxybenzoate, methyl p-toluate, ethyl p-toluate, methyl anisate, and ethyl anisate, 1,3-diethers, organosilicon compounds that include a Si—O—C linkage, and aminosilane compounds that include a Si—N—C linkage are preferred. Organosilicon compounds that include a Si—O—C linkage and aminosilane compounds that include a Si—N—C linkage are more preferred. The silicon or silane compound is used in a molar ratio of less than about 1, preferably from about 0.005 to about 0.5 per mole of the organoaluminium compound.

Specific examples of the organosilicon compound, which contains a Si—O—C linage and may be used as the external electron donor compound, can include one or more compounds selected from, but not limited to: phenylalkoxysilanes, alkylalkoxysilane, phenylalkylalkoxysilanes, cycloalkylalkoxysilane, alkyl(cycloalkylalkoxysilanes, (alkyamino)alkoxysilanes, alkyl(alkylamino)alkoxysilanes, cycloalkyl(alkylamino)alkoxysilanes, tetraalkoxysilanes, tetrakis(alkylamino)silanes, alkyltris(alkylamino)silanes, dialkylbis(alkylamino)silanes, trialkyl(alkylamino)silanes, n-propyltriethoxysilane, cyclopentyltriethoxysilane, phenyltrimethoxysilane, phenyltriethoxysilane, t-butyltrimethoxysilane, diisopropyldimethoxysilane, isopropylisobutyldimethoxysilane, diisopentyldimethoxysilane, bis(2-ethylhexyl)dimethoxysilane, t-butylmethyldimethoxysilane, t-butylethyldimethoxysilane, dicyclopentyldimethoxysilane, dicyclohexyldimethoxysilane, cyclohexylcyclopentyldimethoxysilane, cyclohexylmethyldimethoxysilane, tetraethoxysilane, tetrabutoxysilane, bis(ethylamino)methylethylsilane, bis(ethylamino-t-butylmethylsilane, dicyclopentylbis(ethylamino)silane, bis(ethylamino)dicyclohexylsilane, bis(methylamino)(methylcyclopentylamino)methylsilane, diethylaminotriethoxysilane, bis(cyclohexylaminodimethoxysilane, bis(perhydroisoquinolino)dimethoxysilane, bis(perhydroquinolino)dimethoxysilane, ethyl(isoquinolino)dimethoxysilane. trimethylmethoxysilane, diphenyldimethoxysilane, isobutyltriethoxysilane, vinyltrimethoxysilane, 3-tert-Butyl-2-isobutyl-2methoxy-[1,3,2]oxazasilolidine, 3-tert-Butyl-2-cyclopentyl-2-methoxy-[1,3,2]oxazasilolidine, 2-Bicyclo[2.2.1]hept-5-en-2-yl-3-tert-butyl-2-methoxy-[1,3,2] oxazasilolidine, 3-tert-Butyl-2,2-diethoxy-[1,3,2] oxazasilolidine, 4,9-Di-tert-butyl-1,6-dioxa-4,9-diaza-5-sila-spiro[4.4]nonane, and bis (perhydroisoquinolino) dimethoxysilane. Mixtures of organic electron donors may also be used. Finally, oxalic acid diamides may also be employed as an external electronic donor. Other organosilicon compounds, which may be used as external donors, are discussed in U.S. Pat. Nos. 7,619,049, 7,790,819, 8,575,283, 9,790,291, 9,951,152, and 10,124,324, each of which is incorporated by reference herein in its entirety.

The olefin polymerization catalyst of the present invention may be obtained by bringing the solid catalyst component, the organoaluminum compound, and the external electron donor compound into contact each other. It is preferred that the order of contact with each other follows organoaluminum compound, external electron donor compound, and then solid catalyst component. The olefin polymerization catalyst of the present invention thus provides excellent olefin polymerization activity and superior hydrogen response, and produces an olefin polymer having high MFR and stereoregularity.

The olefin may be homopolymerized, or copolymerized with another olefin. The olefin that is polymerized using the catalyst component or olefin polymerization catalyst of the present invention may be one or more olefins selected from ethylene, propylene, 1-butene, 1-pentene, 4-methyl-1-pentene, and the like. Propylene may be copolymerized with another olefin. Among these, ethylene, propylene, and 1-butene are preferred, and propylene is most preferred. Propylene may be copolymerized with another olefin. It is preferred to subject propylene and another α-olefin to create block copolymerization. A block copolymer obtained by block copolymerization is a polymer that includes two or more segments in which the monomer composition changes sequentially.

The olefin may be polymerized using olefin polymerization catalyst according to the present invention in the presence or absence of an organic solvent. The olefin may be polymerized in a gaseous state or a liquid sate. A continuous polymerization process or a batch polymerization process may be used. The olefin may be polymerized in a single step, or may be polymerized in two or more steps.

Examples of polymerization processes include a slurry polymerization method that utilizes an inert hydrocarbon solvent such as heptane or cyclohexane, a bulk polymerization method that utilizes a solvent such as liquefied propylene, and a gas-phase polymerization method in which a solvent is not substantially used. Among these, a bulk polymerization method and a gas-phase polymerization method are preferred.

The components of the olefin polymerization catalyst according to the present invention may be brought into contact with the olefin in an arbitrary order. It is preferred to add the organoaluminum compound to a polymerization system that contains an inert gas atmosphere or an olefin gas atmosphere, add the solid catalyst component for olefin polymerization system, and bring one or more olefins (e.g., propylene) into contact with the mixture. It is also preferred to add the organoaluminum compound to a polymerization system that contains an inert gas atmosphere or an olefin gas atmosphere, add the external electron donor compound to the polymerization system, add the solid catalyst component for olefin polymerization system, and then bring one or more olefins (e.g., propylene) into contact with the mixture.

When implementing the process for producing an olefin polymer according to the present invention, the polymerization temperature is normally 200° C. or less. The polymerization temperature is preferably about 100° C. or less, more preferably about 60 to about 100° C., and most preferably about 70 to about 90° C., from the viewpoint of improving activity and stereoregularity. When implementing the process for producing an olefin polymer according to the present invention, the polymerization pressure is preferably about 10 MPa or less, and more preferably about 5 MPa or less.

The molecular weight of the polymers may be controlled by known methods, preferably by using hydrogen. With the catalyst component produced according to the present invention, molecular weight may be suitably controlled with hydrogen when the polymerization is carried out at relatively low temperatures, e.g., from about 30° C. to about 105° C. This control of molecular weight may be evidenced by a measurable positive change of the Melt Flow Rate (MFR).

### EXAMPLES

In order to provide a better understanding of the present invention, the following non-limiting examples are listed below. Although the examples may be directed to specific embodiments, in no way should the following examples be read to limit or define the entire scope of the invention.

The following EDTA titration method was used to determine the content of magnesium in solid catalyst component: The slurry catalyst component was dried under reduced pressure to completely remove solvent. The dried solid catalyst component was weighed and dissolved in a hydrochloric acid solution. After the addition of methyl orange (indicator) and a saturated ammonium chloride solution, the mixture was neutralized with aqueous ammonia, heated, cooled, and filtered to remove a precipitate (titanium hydroxide). A given amount of the filtrate was isolated, and heated. After adding a buffer and an EBT mixed indicator, the filtrate was titrated using an EDTA solution to determine the content of magnesium in the solid catalyst component.

Oxidation-reduction titration was used to determine the content of titanium in the solid catalyst component. Halogen content was determined by using an automatic titration device. The slurry catalyst component was dried under reduced pressure to completely remove solvent. The dried solid catalyst component was weighed, treated with a mixture of sulfuric acid and purified water to obtain an aqueous solution. A given amount of the aqueous solution was isolated, and titrated with a silver nitrate standard solution.

GC/MS (Gas Chromatograph with Mass Spectrometry) was used to characterize, determine, and monitor the changes of compounds and reaction progress. The GC/MS measurement was from Agilent 7890B gas-chromatography. Agilent G4567A auto-injector and Agilent 5977A mass spectra detector. The Agilent instrument information is incorporated herein by reference.

The polymerization activity is calculated by mass (g) of polymer produced per gram of the solid catalyst component.

The melt flow rate (MFR) (melt flow index, g/10 min) of the polymer was measured in accordance with ASTM D1238 at 230° C. with a load of 2.16 kg.

Isotacticity of polypropylene is determined based on xylene-soluble content (XS) of polymer. A flask equipped with a stirrer was charged with 5.0 g of the polymer (polypropylene) and 200 ml of p-xylene. The external temperature was increased to be equal to or higher than the boiling point (about 150° C.) of xylene, and the polymer was dissolved over 2 hours, while maintaining p-xylene solvent in the flask at a temperature in the range of 137 to 138° C. under the condition of boiling point. The solution was cooled to 23° C. over 1 hour, and an insoluble portion and soluble portion were separated by filtration. A solution of soluble portion was collected, and p-xylene was evaporated by heating under reduced pressure. The residue was collected and weighed. The xylene-soluble content (XS) was calculated by the relative ratio (mass %) with respect to the polymer. The xylene-soluble content (XS) is defined as the atactic component of polypropylene, and the xylene-insoluble content is defined as isotactic component of polypropylene.

Isotactic index was calculated based on the heptane insoluble weight percentage (wt. %). Approximately 15-20 g of the completely dried polymer was extracted with refluxing heptane for 8 hours. The weight percent (wt. %) of insoluble polymer was collected and dried to calculate the heptane insoluble weight percentage (wt. %). The heptane insoluble weight percentage (wt. %) was defined as isotactic index.

### Example 1

### (A) Preparation of a Solid Catalyst Component

To a three-neck 250 ml flask equipped with a stirrer and thermometer, which was thoroughly purged with anhydrous nitrogen, 10.0 g of magnesium ethoxide and 80 ml of anhydrous toluene was introduced to form a suspension and the mixture was heated to gradually raise temperature to 60° C. 1.8 g isobutanol and 2.3 g phthaloyl chloride, dissolved in anhydrous toluene 15 ml, were slowly added through a stainless steel cannula. The mixture of magnesium ethoxide, phthaloyl chloride and isobutanol were stirred at 60° C. for 3 hours, which was monitored with GC-MS until the peak of phthaloyl chloride disappeared. The mixture was cooled to room temperature and kept overnight.

The mixture was cooled below −20° C. and 30 ml TiCl₄ was slowly added. The mixture was slowly heated to 80° C. and stirred for 2 hours. The hot mixture was transferred into a Schlenk type reactor equipped with a mechanical and a fritted filter disc, which was heated and maintained at the temperature 110° C. The resulting solid was filtered and washed twice with 40 ml of anhydrous toluene at 100° C. 80 ml of fresh anhydrous toluene and 25 ml TiCl₄ was added to the filtered solid and then the mixture was heated to 110° C. and stirred for 2 hours.

The mixture was filtered and the resulting solid washed twice with 40 ml of anhydrous toluene at 100° C. 80 ml of fresh anhydrous toluene and 25 ml TiCl₄ was added to the filtered solid, and then the mixture was heated to 110° C. and stirred for 2 hours.

The residual solid was filtered and washed with anhydrous toluene three times at 90° C., and then with anhydrous heptane twice at 90° C. and one time at ambient temperature. The final catalyst component was collected and dried under vacuum to obtain a solid composition.

### (B) Propylene Slurry Polymerization

Propylene was polymerized using a laboratory scale 2 liter stainless steel autoclave equipped with a stirrer and a jacket for heating and cooling, which was heated to a temperature above 100° C. to expel all traces of moisture and air with a nitrogen purge. After allowing the reactor to cool to 50° C. under nitrogen, one liter of anhydrous heptane was introduced into the autoclave, successively followed by adding 2.5 mmol of triethyl aluminum, and then 0.2 mmol of diisopropyldimethoxysilane (P-donor), and then about 30.0 mg of the solid catalyst obtained above. The autoclave was kept at 50° C. and the pressure of autoclave was controlled about 5.0 psig with nitrogen. Hydrogen in a 150 ml vessel with a pressure of 8 psig was flushed into the reactor with propylene.

The reactor was then raised to 70° C. and the total reactor pressure was raised to 90 psig by feeding propylene. The reaction was maintained for 1 hour under this condition with a continuous propylene feed to maintain a constant pressure during the course of the polymerization. The system was then cooled to 50° C. and vented to reduce the pressure to 0 psig. The reactor was opened and 500 ml methanol was added to the reactor and the resulting mixture was stirred for 10 minutes and then filtered to obtain the polymer. The obtained polymer was dried under vacuum at 80° C. for 6 hours. The polymer was weighed and tested with melt flow rate (MFR) and isotactic index (heptane insoluble wt. %). The results were listed in Table 1.

### Example 2

### (A) Preparation of a Solid Catalyst Component

To a three-neck 250 ml flask equipped with a stirrer and thermometer, which was thoroughly purged with anhydrous nitrogen, 10.0 g of magnesium ethoxide and 80 ml of anhydrous toluene was introduced to form a suspension and the mixture was heated to gradually raise temperature to 80° C. 1.8 g isobutanol and 2.3 g phthaloyl chloride, dissolved in anhydrous toluene 10 ml, were slowly added through a stainless steel cannula. The mixture of magnesium ethoxide, phthaloyl chloride and isobutanol were stirred at 80° C. for 2 hours, which was monitored with GC-MS until the peak of phthaloyl chloride disappeared. The mixture was cooled to room temperature and kept overnight.

After the solution of 1.15 g epichlorohydrin and 3.0 g tributylphosphate, dissolved in anhydrous toluene 15 ml, were added into the mixture through a stainless steel cannula, the mixture was heated to 50° C., and stirred for 1.5 hours. The mixture was cooled below −20° C. and 30 ml TiCl₄ was slowly added. The mixture was slowly heated to 80° C. and stirred for 2 hours. The hot mixture was transferred into a Schlenk type reactor equipped with a mechanical and a fritted filter disc, which was heated and maintained at the temperature 110° C. The resulting solid was filtered and washed twice with 40 ml of anhydrous toluene at 100° C. 80 ml of fresh anhydrous toluene and 25 ml TiCl₄ was added to the filtered solid and then the mixture was heated to 110° C. and stirred for 2 hours.

The mixture was filtered and the resulting solid washed twice with 40 ml of anhydrous toluene at 100° C. 80 ml of fresh anhydrous toluene and 25 ml TiCl₄ was added to the filtered solid, and then the mixture was heated to 110° C. and stirred for 2 hours.

The residual solid was filtered and washed with anhydrous toluene three times at 90° C., and with anhydrous heptane twice at 90° C. and one time at ambient temperature. The final catalyst component was collected and dried under vacuum to obtain a solid composition.

### (B) Propylene Slurry Polymerization

The propylene polymerization procedure was the same as described in Example 1. The polymers were weighed and tested with melt flow rate (MFR) and isotactic index (heptane insoluble wt. %). The results were listed in Table 1.

### (C) Propylene Bulk Polymerization

Propylene bulk polymerization was conducted in a laboratory scale liter stainless steel autoclave equipped with a stirrer and a jacket for heating and cooling, which was heated to a temperature above 100° C. to expel all traces of moisture and air with a nitrogen purge. After allowing the reactor to cool to 70° C. under nitrogen, 3 mmol of triethyl aluminum and 0.25 mmol of diisopropyldimethoxysilane (P-donor) were introduced into the autoclave, successively followed by adding about 7 mg of the solid catalyst obtained above, and then hydrogen, and then 1.2 liter of liquefied propylene to start the polymerization. The reaction was maintained for 1 hour under this condition with stirring. The system was then stopped heating and vented to reduce the pressure to 0 psi. The obtained polymer was dried under vacuum at 80° C. for 6 hours. The polymer was weighed and tested with melt flow rate (MFR) and isotactic index (heptane insoluble wt. %). The results were listed in Table 2.

### Example 3

The catalyst component was prepared by following the procedure of Example 2, except that 3.6 g isobutanol and 4.6 g phthaloyl chloride were used to react with 10.0 g of magnesium ethoxide at 60° C. 2.3 g epichlorohydrin and 6.0 g tributylphosphate was used. The final catalyst was collected and dried under vacuum to obtain a solid composition.

The propylene slurry polymerization procedure was the same as described in Example 1. The polymers were weighed and tested with melt flow rate (MFR) and isotactic index (heptane insoluble wt. %). The results were listed in Table 1.

### Example 4

The catalyst component was prepared by following the procedure of Example 2, except that 0.46 g isobutanol and 2.5 g phthaloyl chloride were used to react with 10.0 g of magnesium ethoxide at 60° C. The final catalyst was collected and dried under vacuum to obtain a solid composition.

The propylene slurry polymerization procedure was the same as described in Example 1. The polymers were weighed and tested with melt flow rate (MFR) and isotactic index (heptane insoluble wt. %). The results were listed in Table 1.

### Comparative Example 1

### (A) Preparation of a Solid Catalyst Component

To a three-neck 250 ml flask equipped with a stirrer and thermometer, which was thoroughly purged with anhydrous nitrogen, 10.0 g of magnesium ethoxide and 100 ml of anhydrous toluene was introduced to form a suspension. 25 ml TiCl₄ was slowly added into the mixture at room temperature. The mixture was heated to gradually raise temperature to 45° C., and then 3.1 g diisobutyl phthalate was added. The temperature of mixture was slowly increased to 110° C. and maintained for 2 hours with stirring.

The hot mixture was transferred into a Schlenk type reactor equipped with a mechanical and a fritted filter disc, which was heated and maintained at the temperature 100° C. The resulting solid was filtered and washed twice with 40 ml of anhydrous toluene at 100° C. 80 ml of fresh anhydrous toluene and 25 ml TiCl₄ was added to the filtered solid and then the mixture was heated to 110° C. and stirred for 2 hours.

The residual solid was filtered and washed with anhydrous toluene three times at 90° C., and with anhydrous heptane twice at 90° C. and one time at ambient temperature. The final catalyst component was collected and dried under vacuum to obtain a solid composition.

### (B) Propylene Slurry Polymerization

The propylene polymerization procedure was the same as described in Example 1. The polymers were weighed and tested with melt flow rate (MFR) and isotactic index (heptane insoluble wt. %). The results were listed in Table 1.

### (C) Propylene Bulk Polymerization

The propylene bulk polymerization procedure was the same as described in Example 2. The polymers were weighed and tested with melt flow rate (MFR) and isotactic index (heptane insoluble wt. %). The results were listed in Table 2.

TABLE 1

| | Polymerization | | Isotactic index | XS |
|---|---|---|---|---|
| | activity | MFR | (heptane insoluble | (mass |
| | (g-PP/g-cat) | (g/10 min) | mass %) | %) |
| Example 1 | 5516.7 | 1.1 | 99.0 | 1.6 |
| Example 2 | 8753.3 | 0.7 | 99.3 | 1.2 |
| Example 3 | 4380.0 | 1.3 | 98.9 | 2.0 |
| Example 4 | 5670.0 | 0.9 | 99.2 | 1.5 |
| Comparative | 5336.7 | 2.1 | 98.7 | 2.3 |
| Example 1 | | | | |

TABLE 2

| | Polymerization | | Isotactic index | XS |
|---|---|---|---|---|
| | activity | MFR | (heptane insoluble | (mass |
| | (g-PP/g-cat) | (g/10 min) | mass %) | %) |
| Example 2 | 50285.7 | 1.5 | 98.8 | 2.0 |
| Comparative | 30200.0 | 7.1 | 98.4 | 2.2 |
| Example 1 | | | | |

### Example 5

### (A) Preparation of a Solid Catalyst Component

To a three-neck 250 ml flask equipped with a stirrer and thermometer, which was thoroughly purged with anhydrous nitrogen, 10.0 g of magnesium ethoxide and 100 ml of anhydrous toluene was introduced to form a suspension and the mixture was heated to gradually raise temperature to 80° C. 1.15 g 2,4-pentane diol and 3.7 g benzoyl chloride, dissolved in anhydrous toluene 10 ml, were slowly added through a stainless steel cannula. The mixture of magnesium ethoxide, benzoyl chloride and 2,4-pentane diol were stirred at 80° C. for 10 minutes, and then stirred at 100° C. for 4 hours, which was monitored with GC-MS until the peak of benzoyl chloride disappeared. The mixture was cooled to room temperature and kept overnight.

The mixture was stirred at room temperature and 30 ml TiCl₄ was slowly added. The mixture was slowly heated to 100° C. and stirred for 2 hours. The hot mixture was transferred into a Schlenk type reactor equipped with a mechanical and a fritted filter disc, which was heated and maintained at the temperature 110° C. The resulting solid was filtered and washed twice with 40 ml of anhydrous toluene at 100° C. 80 ml of fresh anhydrous toluene and 25 ml TiCl₄ was added to the filtered solid and then the mixture was heated to 110° C. and stirred for 2 hours.

The residual solid was filtered and washed with anhydrous toluene three times at 90° C., and with anhydrous heptane twice at 90° C. and one time at ambient temperature. The final catalyst component was collected and dried under vacuum to obtain a solid composition.

### (B) Propylene Slurry Polymerization

The propylene slurry polymerization procedure was the same as described in Example 1. The polymers were weighed and tested with melt flow rate (MFR) and isotactic index (heptane insoluble wt. %). The results were listed in Table 3.

### Example 6

The catalyst component was prepared by following the procedure of Example 5, except that 1.15 g 2,4-pentane diol and 3.4 g benzoyl chloride were used to react with 10.0 g of magnesium ethoxide at 120° C. for 20 minutes. The final catalyst was collected and dried under vacuum to obtain a solid composition.

The propylene polymerization procedure was the same as described in Example 1. The polymers were weighed and tested with melt flow rate (MFR) and isotactic index (heptane insoluble wt. %). The results were listed in Table 3.

### Example 7

To a three-neck 250 ml flask equipped with a stirrer and thermometer, which was thoroughly purged with anhydrous nitrogen, 10.0 g of magnesium ethoxide and 80 ml of anhydrous toluene was introduced to form a suspension and the mixture was heated to gradually raise temperature to 60° C. 1.15 g 2,4-pentane diol and 3.3 g benzoyl chloride, dissolved in anhydrous toluene 10 ml, were slowly added through a stainless steel cannula. The mixture of magnesium ethoxide, 3.3 g benzoyl chloride and 2,4-pentane diol were stirred at 60° C. for 3 hours, which was monitored with GC-MS until the peak of benzoyl chloride disappeared. The mixture was cooled to room temperature and kept overnight.

The remaining procedure was the same as described in Example 2. The final catalyst was collected and dried under vacuum to obtain a solid composition.

The propylene slurry polymerization procedure was the same as described in Example 1. The polymers were weighed and tested with melt flow rate (MFR) and isotactic index (heptane insoluble wt. %). The results were listed in Table 4.

### Example 8

The catalyst component was prepared by following the procedure of Example 7, except that except that 1.5 g 2,4-pentane diol and 4.3 g benzoyl chloride were used to react with 10.0 g of magnesium ethoxide at 50° C. for 6 hours. The final catalyst was collected and dried under vacuum to obtain a solid composition.

The propylene slurry polymerization procedure was the same as described in Example 1. The polymers were weighed and tested with melt flow rate (MFR) and isotactic index (heptane insoluble wt. %). The results were listed in Table 4.

### Comparative Example 2

The catalyst component was prepared by following the procedure of Comparative Example 1, except that 3.2 g 2,4-pentanediol dibenzoate was added when the mixture was heated to gradually raise temperature to 40° C. The final catalyst was collected and dried under vacuum to obtain a solid composition.

The propylene slurry polymerization procedure was the same as described in Example 1. The polymers were weighed and tested with melt flow rate (MFR) and isotactic index (heptane insoluble wt. %). The results were listed in Table 3.

TABLE 3

| | Polymerization | | Isotactic index |
|---|---|---|---|
| | activity | MFR | (heptane insoluble |
| | (g-PP/g-cat) | (g/10 min) | mass %) |
| Example 5 | 2420.0 | 6.0 | 97.5 |
| Example 6 | 1823.3 | 3.5 | 97.4 |
| Example 7 | 8786.7 | 1.1 | 97.8 |
| Example 8 | 4030.0 | 3.7 | 96.3 |
| Comparative | 1346.7 | 5.4 | 95.8 |
| Example 2 | | | |

### Example 9

### (A) Preparation of a Solid Catalyst Component

To a three-neck 250 ml flask equipped with a stirrer and thermometer, which was thoroughly purged with anhydrous nitrogen, 10.0 g of magnesium ethoxide, 2.5 g diethylmalonyl dichloride and 100 ml of anhydrous toluene was introduced to form a suspension. The mixture was stirred at room temperature overnight, and then heated to 70° C. and stirred for 3 hours, which was monitored with GC-MS until the peak of diethylmalonyl dichloride. The mixture was stirred at 90° C. for 3 hours, and then stirred at 105° C. for 6 hours. The mixture was cooled to room temperature and kept overnight.

After the solution of 1.2 g epichlorohydrin and 3.1 g tributylphosphate, dissolved in anhydrous toluene 15 ml, were added into the mixture through a stainless steel cannula, the mixture was heated to 50° C., and stirred for 3 hours. The mixture was cooled in ice bath and 30 ml TiCl₄ was slowly added. The mixture was slowly heated to 80° C. and stirred for 2 hours. The hot mixture was transferred into a Schlenk type reactor equipped with a mechanical and a fritted filter disc, which was heated and maintained at the temperature 110° C. The resulting solid was filtered and washed twice with 40 ml of anhydrous toluene at 100° C. 80 ml of fresh anhydrous toluene and 25 ml TiCl₄ was added to the filtered solid, and then the mixture was heated to 110° C. and stirred for 2 hours.

The mixture was filtered and the resulting solid washed twice with 40 ml of anhydrous toluene at 100° C. 80 ml of fresh anhydrous toluene and 25 ml TiCl₄ was added to the filtered solid, and then the mixture was heated to 110° C. and stirred for 2 hours.

The residual solid was filtered and washed with anhydrous toluene three times at 90° C., and with anhydrous heptane twice at 90° C. and one time at ambient temperature. The final catalyst component was collected and dried under vacuum to obtain a solid composition.

### (B) Propylene Slurry Polymerization

The propylene polymerization procedure was the same as described in Example 1. The polymers were weighed and tested with melt flow rate (MFR) and isotactic index (heptane insoluble wt. %). The results were listed in Table 4.

### Comparative Example 3

The catalyst component was prepared by following the procedure of Comparative Example 1, except that 2.7 diethyl diethylmalonate was added instead of 3.1 g diisobutyl phthalate when the mixture was heated to gradually raise temperature to 80° C. The final catalyst was collected and dried under vacuum to obtain a solid composition.

The propylene slurry polymerization procedure was the same as described in Example 1. The polymers were weighed and tested with melt flow rate (MFR) and isotactic index (heptane insoluble wt. %). The results were listed in Table 4.

### Example 10

The catalyst component was prepared by following the procedure of Example 9, except that only 1.8 g succinyl chloride instead of 2.5 g diethylmalonyl dichloride was used to react with 10.0 g of magnesium ethoxide at 50° C. for 4 hours. The final catalyst was collected and dried under vacuum to obtain a solid composition.

The propylene slurry polymerization procedure was the same as described in Example 1. The polymers were weighed and tested with melt flow rate (MFR) and isotactic index (heptane insoluble wt. %). The results were listed in Table 4.

### Comparative Example 4

The catalyst component was prepared by following the procedure of Comparative Example 1, except that 1.9g diethylsuccinate was added instead of 3.1 g diisobutyl phthalate when the mixture was stirred in ice bath during TiCl₄ adding. The final catalyst was collected and dried under vacuum to obtain a solid composition.

The propylene slurry polymerization procedure was the same as described in Example 1. The polymers were weighed and tested with melt flow rate (MFR) and isotactic index (heptane insoluble wt. %). The results were listed in Table 4.

TABLE 4

| | Polymerization | | Isotactic index |
|---|---|---|---|
| | activity | MFR | (heptane insoluble |
| | (g-PP/g-cat) | (g/10 min) | mass %) |
| Example 9 | 3586.7 | 7.1 | 94.0 |
| Comparative | 1736.7 | 21.4 | 96.3 |
| Example 3 | | | |
| Example 10 | 2316.7 | 2.7 | 97.7 |
| Comparative | 1023.3 | 6.5 | 97.0 |
| Example 4 | | | |

### Example 11

### (A) Preparation of a Solid Catalyst Component

To a three-neck 250 ml flask equipped with a stirrer and thermometer, which was thoroughly purged with anhydrous nitrogen, 10.0 g of magnesium ethoxide and 50 ml of anhydrous toluene was introduced to form a suspension. 2.3 g 5-tert-butyl-3-methylbenzene-1,2-diol and 1.9 g benzoyl chloride, dissolved in anhydrous toluene 30 ml, were slowly added through a stainless steel cannula. The mixture was stirred at room temperature for 4.5 hours, which was monitored with GC-MS until the peak of benzoyl chloride disappeared. The mixture was gradually heated to 90° C. and stirred for 2.5 hours, and then 2.2 g benzoyl chloride was added. The mixture was stirred at 90° C. for 2 hours. The mixture was cooled to room temperature and kept overnight.

The mixture was cooled to room temperature and 20 ml TiCl₄ was slowly added. The mixture was slowly heated to 100° C. and stirred for 2 hours. The hot mixture was transferred into a Schlenk type reactor equipped with a mechanical and a fritted filter disc, which was heated and maintained at temperature 110° C. The resulting solid was filtered and washed twice with 40 ml of anhydrous toluene at 100° C. 80 ml of fresh anhydrous toluene and 25 ml TiCl₄ was added to the filtered solid and then the mixture was heated to 110° C. and stirred for 2 hours.

The mixture was filtered and the resulting solid washed twice with 40 ml of anhydrous toluene at 100° C. The mixture was filtered and the resulting solid washed twice with 40 ml of anhydrous toluene at 100° C. 80 ml of fresh anhydrous toluene and 25 ml TiCl₄ was added to the filtered solid, and then the mixture was heated to 110° C. and stirred for 2 hours.

The residual solid was filtered and washed with anhydrous toluene three times at 90° C., and with anhydrous heptane twice at 90° C. and one time at ambient temperature. The final catalyst component was collected and dried under vacuum to obtain a solid composition.

### (B) Propylene Slurry Polymerization

The propylene polymerization procedure was the same as described in Example 1. The polymers were weighed and tested with melt flow rate (MFR) and isotactic index (heptane insoluble wt. %). The results were listed in Table 5.

### Example 12

The catalyst component was prepared by following the procedure of Example 11 except that the mixture of 1.8 g 5-tert-butyl-3-methylbenzene-1,2-diol and 1.9 g benzoyl chloride was added and the mixture was heated at 100° C. and stirred for 1 hour. The final catalyst was collected and dried under vacuum to obtain a solid composition.

The propylene slurry polymerization procedure was the same as described in Example 1. The polymers were weighed and tested with melt flow rate (MFR) and isotactic index (heptane insoluble wt. %). The results were listed in Table 5.

### Example 13

The catalyst component was prepared by following the procedure of Example 11, except that the mixture of 1.8 g 5-tert-butyl-3-methylbenzene-1,2-diol and 3.1 g benzoyl chloride was added and the mixture was heated at 80° C. and stirred for 3 hour. The final catalyst was collected and dried under vacuum to obtain a solid composition.

The propylene slurry polymerization procedure was the same as described in Example 1. The polymers were weighed and tested with melt flow rate (MFR) and isotactic index (heptane insoluble wt. %). The results were listed in Table 5.

### Comparative Example 5

The catalyst component was prepared by following the procedure of Comparative Example 11, except that 1.9 g 5-tert-butyl-3-methylbenzene-1,2-diol dibenzoate was added instead of 2.3 g 5-tert-butyl-3-methylbenzene-1,2-diol and 1.9 g benzoyl chloride when the mixture was stirred in ice bath during TiCl₄ adding. The final catalyst was collected and dried under vacuum to obtain a solid composition.

The propylene slurry polymerization procedure was the same as described in Example 1. The polymers were weighed and tested with melt flow rate (MFR) and isotactic index (heptane insoluble wt. %). The results were listed in Table 5.

### Example 14

### (A) Preparation of a Solid Catalyst Component

To a three-neck 250 ml flask equipped with a stirrer and thermometer, which was thoroughly purged with anhydrous nitrogen, 10.0 g of magnesium ethoxide, 1.15 g 2,4-pentane diol and 80 ml of anhydrous toluene was introduced to form a suspension. The mixture was heated to 100° C. and the mixture of 2.44 g benzoyl chloride and 1.37 g diphenylphosphinic chloride dissolved in 30 ml toluene was added slowly. The mixture was stirred for 30 minutes at 100° C. and the mixture was cooled to room temperature and kept overnight.

The remaining procedure of Example 14 was same as in Example 11. The final catalyst was collected and dried under vacuum to obtain a solid composition.

### (B) Propylene Slurry Polymerization

The propylene polymerization procedure was the same as described in Example 1. The polymers were weighed and tested with melt flow rate (MFR) and isotactic index (heptane insoluble wt. %). The results were listed in Table 5.

### Example 15

### (A) Preparation of a Solid Catalyst Component

To a three-neck 250 ml flask equipped with a stirrer and thermometer, which was thoroughly purged with anhydrous nitrogen, 10.0 g of magnesium ethoxide, 1.15 g 2,4-pentane diol and 80 ml of anhydrous toluene was introduced to form a suspension. The mixture was heated to 100° C. and 1.3 g diphenylphosphinic chloride dissolved in 10 ml toluene was added first. After the mixture was stirred at 100° C. for 5 minutes, 2.44 g benzoyl chloride was added. The mixture was stirred at 100° C. for 2 hours and was cooled to room temperature and kept overnight.

The following procedure of Example 15 was same as the preparation of Example 11. The final catalyst was collected and dried under vacuum to obtain a solid composition.

### (B) Propylene Slurry Polymerization

The propylene polymerization procedure was the same as described in Example 1. The polymers were weighed and tested with melt flow rate (MFR) and isotactic index (heptane insoluble wt. %). The results were listed in Table 5.

### Comparative Example 6

The catalyst component was prepared by following the procedure of Comparative Example 1 except that 2.44 g 2,4-pentanediol dibenzoate and 1.37 g diphenylphosphinic chloride were added when the mixture was heated to gradually raise temperature to 40° C. The final catalyst was collected and dried under vacuum to obtain a solid composition.

The propylene slurry polymerization procedure was the same as described in Example 1. The polymers were weighed and tested with melt flow rate (MFR) and isotactic index (heptane insoluble wt. %). The results were listed in Table 5.

TABLE 5

| | Polymerization | | Isotactic index |
|---|---|---|---|
| | activity | MFR | (heptane insoluble |
| | (g-PP/g-cat) | (g/10 min) | mass %) |
| Example 11 | 3250.0 | 5.0 | 95.5 |
| Example 12 | 3170.0 | 4.8 | 95.7 |
| Example 13 | 2823.3 | 6.0 | 96.0 |
| Comparative | 2135.5 | 5.0 | 94.0 |
| Example 5 | | | |
| Example 14 | 2106.7 | 6.9 | 96.6 |
| Example 15 | 1926.7 | 5.2 | 94.8 |
| Comparative | 1346.7 | 5.4 | 95.8 |
| Example 2 | | | |
| Comparative | 1654.5 | 5.7 | 94.5 |
| Example 6 | | | |

As the above data demonstrate, the polymerization of olefins using the inventive method to prepare the solid catalyst component satisfies the desired requirements of present invention. Internal electron donor compounds reported in the prior art, including phthalates, polycarboxylic acid ester, carboxylic acid ester, diol esters, diethers, and succinates, are not directly used in the present invention. The examples demonstrate that the present invention can form electron donor or internal electron donor intermediates in-situ and create strong synergies having superior catalytic performance to the prior art, as demonstrated in Examples 1-15 as compared with Comparative Examples 1-6. With the reaction between magnesium precursor and halogenation agents, it is possible to achieve polyolefin catalyst components having high stereo-regularity and/or high polymerization activity without any internal donors added. For instance, the catalyst component of Example 2 exhibited higher heptane insoluble (higher isotacticity) and higher polymerization activity comparing with Comparative Example 1. The similar results are also found between Example 7 and Comparative Example 2, Example 9 and Comparative Example 3, Example 10 and Comparative Example 4. As such, the present inventive catalyst system offers more flexibility to applications for polyolefin production.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Whenever a numerical range with a lower limit and an upper limit is disclosed, any number falling within the range is specifically disclosed. Moreover, the indefinite articles “a” or “an”, as used in the claims, are defined herein to mean one or more than one of the element that it introduces.

What is claimed is:

1. A method for producing a solid catalyst component for the polymerization of olefins comprising:
reacting the following compounds to form reaction product (A):
(1) an alkoxymagnesium compound;
(2) one or more of an acyl halide, sulfinyl halide, or sulfonyl halide; and
(3) one or more of an alkanol or an alkanediol;
reacting the reaction product (A) with a halogen-containing titanium compound to obtain a solid catalyst component (C).

2. The method of claim 1, further comprising treating reaction product (C) with tetravalent titanium halide.

3. The method of claim 1, wherein the alkoxymagnesium compound is of the general formula R¹OMgOR², wherein R¹ and R² are independently selected from aliphatic, aromatic, alicyclic, heteroaliphatic, heteroaromatic, or heteroalicyclic groups having 1 to 20 carbon atoms.

4. The method of claim 1, wherein the alkoxymagnesium compound is of the general formula R¹OMgX, wherein R¹ is selected from aliphatic, aromatic, alicyclic, heteroaliphatic, heteroaromatic, or heteroalicyclic groups having 1 to 20 carbon atoms, and wherein X is a halogen.

5. The method of claim 1, wherein the alkoxymagnesium compound comprises a dialkoxy magnesium compound.

6. The method of claim 1, wherein the acyl halide is of the general formula RCOX, wherein R is a linear or branched alkyl or aromatic having 1 to 20 carbon atoms, and wherein X is halogen.

7. The method of claim 1, wherein the acyl halide comprises phthaloyl chloride.

8. The method of claim 1, wherein the sulfinyl halide comprises sulfinyl chloride having the general formula R—S(═O)Cl, wherein R is a linear or branched alkyl or aromatic having 1 to 20 carbon atoms.

9. The method of claim 1, wherein the sulfonyl halide comprises sulfonyl chloride having the general formula R—(O═)S(═O)Cl, wherein R is a linear or branched alkyl or aromatic having 1 to 20 carbon atoms.

10. The method of claim 1, wherein the titanium compound has the general formula TiXₙ(OR)₄₋ₙ, wherein X is a halogen atom, wherein R is a linear or branched alkyl group having 1 to 20 carbon atoms, and wherein n is an integer from 1 to 4.

11. The method of claim 10, wherein R is a linear or branched alkyl group having 1 to 4 carbon atoms.

12. The method of claim 1, wherein the titanium compound comprises titanium tetrachloride.

13. A method for producing a solid catalyst component for the polymerization of olefins comprising:
reacting the following compounds to form reaction product (A):
(1) an alkoxymagnesium compound;
(2) one or more of an acyl halide, sulfinyl halide, or sulfonyl halide; and
(3) one or more of an alkanol or an alkanediol;
reacting the reaction product (A) with one or more of an organohalide or organophosphorus compound to form reaction product (B);
reacting the reaction product (B) with a halogen-containing titanium or vanadium compound to obtain a solid catalyst component (C).

14. The method of claim 13, further comprising treating reaction product (C) with tetravalent titanium halide.

15. The method of claim 13, wherein the organohalide compound has the general formula RX, wherein R is a linear or branched alkyl or aromatic having 1 to 20 carbon atoms, and wherein X is halogen.

16. The method of claim 13, wherein the organohalide compound comprises epichlorohydrin.

17. The method of claim 13, wherein the organophosphorus compound comprises phosphoryl chloride and derivatives thereof.

18. The method of claim 13, wherein the alkoxymagnesium compound is of the general formula R¹OMgOR², wherein R¹ and R² are independently selected from aliphatic, aromatic, alicyclic, heteroaliphatic, heteroaromatic, or heteroalicyclic groups having 1 to 20 carbon atoms.

19. The method of claim 13, wherein the alkoxymagnesium compound is of the general formula R¹OMgX, wherein R¹ is selected from aliphatic, aromatic, alicyclic, heteroaliphatic, heteroaromatic, or heteroalicyclic groups having 1 to 20 carbon atoms, and wherein X is a halogen.

20. The method of claim 13, wherein the alkoxymagnesium compound comprises a dialkoxy magnesium compound.

21. The method of claim 13, wherein the acyl halide is of the general formula RCOX, wherein R is a linear or branched alkyl or aromatic having 1 to 20 carbon atoms, and wherein X is halogen.

22. The method of claim 13, wherein the acyl halide comprises phthaloyl chloride.

23. The method of claim 13, wherein the sulfinyl halide comprises sulfinyl chloride having the general formula R—S(═O)Cl, wherein R is a linear or branched alkyl or aromatic having 1 to 20 carbon atoms.

24. The method of claim 13, wherein the sulfonyl halide comprises sulfonyl chloride having the general formula R—(O═)S(═O)Cl, wherein R is a linear or branched alkyl or aromatic having 1 to 20 carbon atoms.

25. The method of claim 13, wherein the titanium compound has the general formula TiXₙ(OR)₄₋ₙ, wherein X is a halogen atom, wherein R is a linear or branched alkyl group having 1 to 20 carbon atoms, and wherein n is an integer from 1 to 4.

26. The method of claim 25, wherein R is a linear or branched alkyl group having 1 to 4 carbon atoms.

27. The method of claim 13, wherein the titanium compound comprises titanium tetrachloride.

28. An olefin polymerization catalyst, comprising:
the solid catalyst component according to claim 1;
an organoaluminum compound represented by the general formula AlRₙX₃₋ₙ, wherein R is a linear or branched alkyl or aromatic having 1-10 carbon atoms, wherein X is halogen, and wherein n is an integer value meeting the condition of 1<n≤3; and
one or more external electron donors.

29. The catalyst of claim 28, wherein the organoaluminum compound comprises one or more compounds selected from triethylaluminum, diethylaluminum chloride, triisobutylaluminum, diethylaluminum bromide, trioctylaluminum, and diethylaluminum hydride.

30. The catalyst of claim 28, wherein the organoaluminum compound comprises one or more compounds selected from triethylaluminum and triisobutylaluminum.

31. The catalyst of claim 28, wherein the one or more external electron donors comprises an organosilicon compound.

32. The catalyst of claim 28, wherein the one or more external electron donors comprises an aminosilane compound.

33. The catalyst of claim 28, wherein the molar ratio of the one or more external electron donors per mole of the organoaluminum compound is less than about 1.0.

34. The catalyst of claim 28, wherein the molar ratio of the one or more external electron donors to organoaluminum compound is less than about 0.5.

35. The catalyst of claim 28, wherein the molar ratio of organoaluminium compound to titanium in the solid catalyst component is less than about 1000.
